(19) United States
(12) Patent Application Publication
(10) Pub. No.: US 2005/0123453 A1
(43) Pub. Date: Jun. 9, 2005

(54) Sampling vessel with elastic base

(76) Inventor: Guoqing Paul Chen, Thousand Oaks, CA (US)

Correspondence Address: Advenchen Laboratories, LLC, 515 Oakbury Court, Thousand Oaks, CA, 91360, US

(21) Appl. No.: 11/007,112

(22) Filed: Dec. 7, 2004

Related U.S. Application Data
(60) Provisional application No. 60/527,974, filed on Dec. 9, 2003.

(51) Int. Cl. B01L 3/00

(52) U.S. Cl. 422/99

(57) ABSTRACT

The present invention relates to a sampling vessel with an elastic base part for supporting and fixing a small top container part in a larger container part. The elastic base part holds the small container part and the larger container part to constitute a complete vessel as a whole to buffer foreign force with limited move during normal use. Especially, the elastic base in the vessel holds a small glass insert with liquid sample in a larger vial during High Performance Liquid Chromatography (HPLC), Liquid Chromatography (LC) or Liquid Chromatography/Mass (LC/MS) analysis process.

This application claims the benefit of U.S. provisional application No. 60/527,974 filed on Dec. 9, 2003.

The present invention relates to a sampling vessel with an elastic base part for supporting and fixing a small top container part in a larger container part. The elastic base part holds the small container part and the larger container part to constitute a complete vessel as a whole to buffer foreign force with limited move during normal use. Especially, the elastic base in the vessel holds a small glass insert with liquid sample in a larger vial during High Performance Liquid Chromatography (HPLC), Liquid Chromatography (LC) or Liquid Chromatography/Mass (LC/MS) analysis process.

### BACKGROUND OF THE INVENTION

High Performance Liquid Chromatography (HPLC) analysis has been used in food, chemical and pharmaceutical industry for many years. The sampling process has been shift from manual to auto-sampler many years ago. Therefore, the sample container has been changed from syringes for manual use to vials for auto-sampling process. The vials have been developed to have many shapes and many combinations for various functions. The general size for the HPLC sampling vials is about 1-2.5 ml and some smaller amount sample vials are also available on the market. A micro liter glass vial that fused insert (300 μl) with a regular vial (2 ml) as one part in the manufacture for smaller amount of sample, such as protein solution, has been commercially available recent years (Analytical Sales & Service catalogue no. 87203). This product is convenient to use because of its simplicity as one part, but it still cannot avoid possible HPLC needle damage scenario during sample injection because of the hardness of glass. A polyethylene elastic based glass insert (300 μl) (Analytical Sales & Service catalogue no. 10101) has been commercially available as well. This product has the supporting three-leg elastic part to hold top glass part with liquid sample in a larger vial and buffer the injection force to prevent needle damage while sampling, but it has to be inserted into a bigger vial manually during each usage. It cannot be held in the vial straightly and it is easy to be poured out and the inside liquid sample could be spilled out during the sample preparation due to its swaying property. These two products also have been marketed worldwide by the companies, such as Agilent, Waters, National Scientific and VWR scientific etc.

The same or similar sampling vial is used in all other Liquid Chromatography (LC) or Liquid Chromatography/Mass (LC/MS) analysis process for same purpose.

### SUMMARY OF THE INVENTION

The present invention is to provide a complete sampling vessel with an elastic base part for supporting, fixing a small top container part, which reserves a liquid sample, in a larger container part. The elastic base can hold top smaller container part, also can hold the larger container part to make product as a whole that has supporting, fixing functions to let the small container part sitting in the larger container part to buffer the injection force and setting tightly during sampling process. The present invention of the small container part assembled with the elastic base can also be directly inserted into the machine sampler wells that can be designated as the larger container during sampling operation.

The structure of the elastic base (FIG. 1.) in present invention consists of main body that is selected from ring, square or rectangle shape, preferably ring shape (A), attached to at least two spiking winds and at least two supporting legs, preferably three spiking winds (B) and three supporting legs (C). The winds and legs are straight or bended, preferably the winds are straight and the legs are bended. The ring has a certain thickness and height to generate enough strength to hold the winds and the legs that build up as a whole elastic base (Y) to set top part (X) and bottom part (Z) together (FIG. 2.). The material of the elastic base is selected from plastic, rubber, metal wire and steel wire, preferably polyethylene plastic. The material of top small container and bottom larger container parts is selected from glass, plastic, rubber, metal and steel, preferably glass. The bottom container part can be absent as a whole and the machine sampler wells can be used for such purpose.

The typical example of present invention (FIG. 3.) is that the elastic base contains three-wind and three-leg on the main body ring made of polyethylene. The volume of small glass insert is 100 μl to 2 ml, such as 300 μl, squeezes into the main body ring of the base and the resulting part was inserted into the bigger glass vial that is 500 μl to 20 ml, such as 2 ml. The three winds are fixing the insert in a upright position in the vial and holding on the inner surface of the vial and sticking on the bigger container without easy movement unless bigger force pulls the part out, such as fingers pull, to prevent insert slip-off because of its natural elastic force. The major advantage of present invention over the existing products is that it holds the two containers in one part without insert slip-off to make the sample preparation more convenient and no spill. Furthermore, three legs on the base are supporting the desired height and protecting the bottom part of the top container and buffering the injection force from the needle and preventing the break risk to reach the hard bottom of the larger container.

The inner diameter of the main body ring is 0.1 mm to 50 mm, preferably 1 mm to 10 mm. The thickness is 0.2 mm to 5 mm, preferably 0.4 mm to 2 mm. The height of the ring is 0.5 mm to 10 mm, preferably 1 mm to 4 mm. It can be easily squeezed by the insert and hold tight enough without slip-off. The ring diameter usually matches the size of arch part of the small container in order to hold on it tightly.

The wing is located on the ring body or at the top of each leg or on the body of each leg and it is required to be easily inserted into the vial and held on the inner surface properly at its position. It also holds the insert at middle upright position without slip-off even with pouring. The diameter of winds circle is a little larger than the diameter of the bigger container in order to have the elastic force occurring after insertion. The thickness and width of the winds should be controlled to allow the insertion possible. The wind is straight and length can be 0.5 mm to 20 mm, preferably 1 mm to 5 mm; width can be 0.1 mm to 10 mm, preferably 0.2 mm to 4 mm; thickness can be 0.1 mm to 3 mm, preferably 0.2 to 2 mm. The leg is attached to the bottom part of the ring separately and can be straighten or turned and bended to itself to the end. Each leg is independently separated and has the same shape and same length that can be 2 mm to 100 mm, preferably 3 mm to 30 mm. The width of the leg can be 0.2 mm to 10 mm, preferably 0.5 mm to 4 mm and the thickness is the same as the one of the main body ring.

The elastic base in present invention can be made by regular plastic production process that is to make pre-engraved metal or steel mold first and then inject melted plastic such as polyethylene raw material at higher temperature and cooled to room temperature to give the desire shaped product. The pre-shaped small top glass container (300 μl) was inserted into the ring part of present invention made of polyethylene by a little force to set at the arch part of the glass. The resulting part of glass and plastic can be used for the following two manners: 1) it was inserted into another vial (2 ml) as a completed vessel to reserve liquid sample with a cap and put on a sampler well for sampling or 2) it reserves liquid sample and is directly inserted into the base of a sampler that has one to ninety six well positions.

There are usually two closure and seal methods for the present invention; one is the screw cap closure when the lager part is pre-engraved with screw thread after sample filling. Other one is by using snap cap closure to seal the opening area after sample filling. Therefore, either one of the methods could be used to seal the present invention based on the pre-existed structure of larger part after a liquid sample filled. It can be used without cap or sealed with a parafilm for quick sampling when it is directly put on the sampler.

The present invention can be placed in any matching autosampler for HPLC, LC or LC/MS analysis.

### PREPARATION EXAMPLE

Polyethylene beads were heated to melt around 175° C. and injected into pre-engraved sealed steel mold with four cradles inside. The mold was opened after cooling at room temperature for 15 seconds. Four identical products with desired shape were obtained as white elastic, soft ring system with three bended legs and three spikes.

A glass tube (300 μl) with larger sealed bottom and narrow neck was insert into above ring to connect each other as a glass-plastic whole part that was fully inserted into a glass vial (2 ml) to generate the present invention system as a whole.

### BRIEF DESCRIPTION OF THE DRAWING

FIG. 1. shows a stereo view of the elastic base in present invention and further marked A as the main body ring part, B as the wing part and C as the leg part.

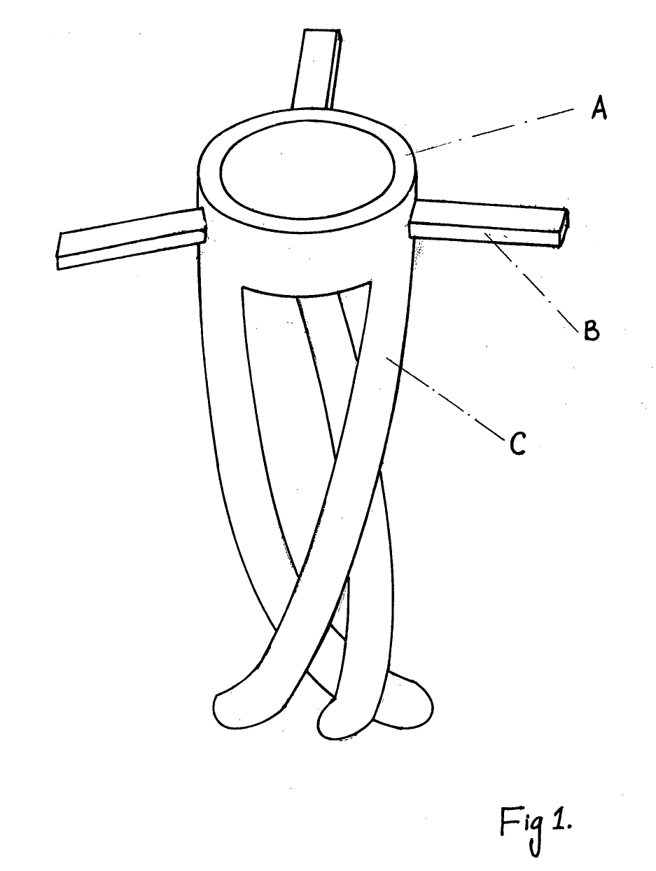

FIG. 2. shows a stereo view of the arrangement of small top container (X), elastic base (Y) and bottom larger container (Z).

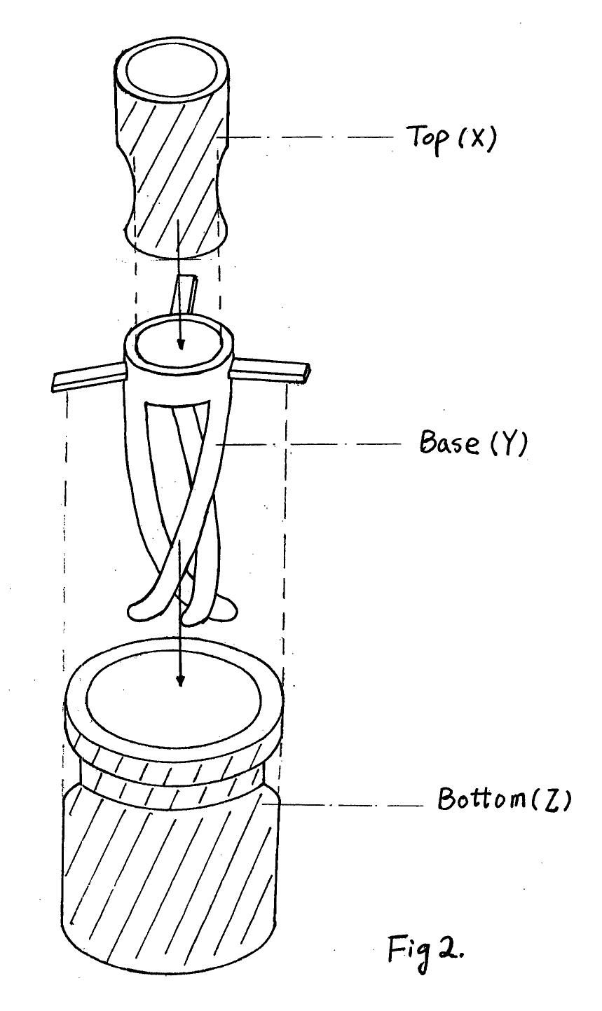

FIG. 3. shows a stereo view of one example of completely assembled present invention that includes the major X, Y and Z parts. It can be sealed with a cap after filled with a liquid sample then put on a sampler well for sampling.

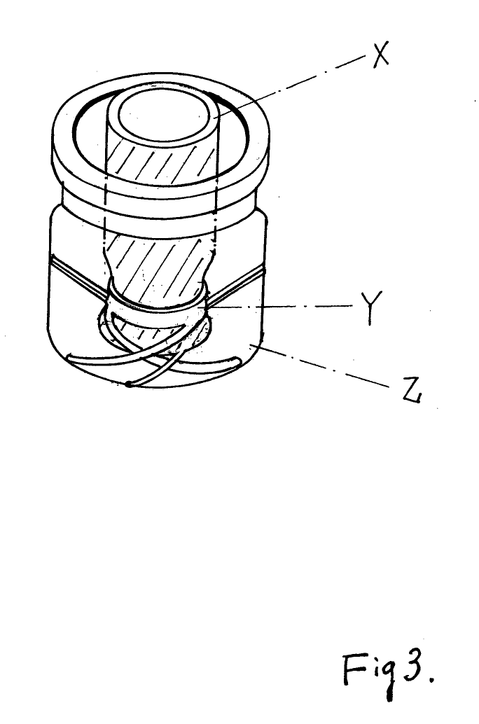

1. A sampling vessel comprises an elastic base part, top container part and a larger container part in which the elastic part holds the top container and the larger container together to form a complete system.

2. The sampling vessel of claim 1 wherein the main body of elastic base part is selected from ring, square or rectangle shape that attaches to at least two spiking winds and at least two supporting legs.

3. The sampling vessel of claim 1 wherein the main body of elastic base part is ring shape that attaches to three spiking winds and three supporting legs.

4. The sampling vessel of claim 1 wherein the material of main body of elastic base part is selected from plastic, rubber, metal wire and steel wire.

5. The sampling vessel of claim 1 wherein the material of main body of elastic base part is polyethylene.

6. The sampling vessel of claim 1 wherein the size of main body of elastic base part is that the ring is at inner diameter 0.1-50 mm, thickness 0.2-5 mm and height 0.5-10 mm.

7. The sampling vessel of claim 1 wherein the material of top container part and larger container part is selected from glass, plastic, rubber, metal and steel.

8. The sampling vessel of claim 1 wherein the material of top container part and larger container part is glass.

9. The sampling vessel of claim 1 wherein the volume of top container part is 100 μl to 2 ml.

10. The sampling vessel of claim 1 wherein the volume of larger container part is 500 μl to 20 ml.

11. The sampling vessel of claim 1 is used in High Performance Liquid Chromatography (HPLC), Liquid Chromatography (LC) or Liquid Chromatography/Mass (LC/MS) analysis process.
